(19) United States
(12) Patent Application Publication
(10) Pub. No.: US 2026/0260342 A1
(43) Pub. Date: Sep. 3, 2026

(54) System for Bone Volume Assessment, Method and Computer-Readable Medium

(71) Applicant: Mriguidance B.V., Utrecht (NL)

(72) Inventors: Peter R. Seevinck, Utrecht (NL); Tijl A. Van Der Velden, Utrecht (NL)

(21) Appl. No.: 19/489,220

(22) PCT Filed: May 29, 2024
(86) PCT No.: PCT/EP2024/064701

§ 371 Date: Dec. 1, 2025

(30) Foreign Application Priority Data
May 30, 2023 (EP) 23176000.0

(51) Int. Cl. G06T 7/00; G06T 7/62

(52) U.S. Cl. CPC G06T 7/0012; G06T 7/62; G06T 2207/10081; G06T 2207/10088; G06T 2207/20081; G06T 2207/30008

(57) ABSTRACT

The present invention relates to a system for bone volume assessment based on at least one of MRI patient scan data and at least one set of synthetic CT data, comprising at least one processor module and at least one storage module for storing patient data, wherein the processor module is configured to process and/or analyse MRI patient scan data, at least one set of synthetic CT data and/or the reduced patient data, preferably in combination with each other, such that at least one bone volume parameter, in particular bone mineral density, fat percentage, calcium concentration, total density trabecular space and/or the like, of a first patient is determined. Moreover, the invention refers to a corresponding method and a computer-readable medium.

### CROSS-REFERENCE TO RELATED APPLICATIONS

This application is the national phase of, and claims priority to, international application PCT/EP2024/064701 filed May 29, 2024, which claims priority to European Patent Application No. 23176000A, filed May 30, 2023.

### FIELD OF THE INVENTION

The invention relates to a system for bone volume assessment based on MRI patient scan data and/or at least one set of synthetic CT data, a corresponding method and a computer-readable medium.

### BACKGROUND

According to the prior art, the inherent limitations of both Magnetic Resonance Imaging (MRI) and Computed Tomography Imaging (CT) have recently been tried to be compensated by parallel and combined use of both technologies.

For example, bone marrow can be affected by various pathologies, such as bone bruises after trauma and diffuse tumor infiltrations or osteoporosis and the like. Up to now, the major modalities for imaging of these pathologies have been MRI and CT, either only one of them being applied or both of them side by side, e.g. in the context of radiotherapy treatment planning, PET attenuation correction and bone quality assessment. Hence, various approaches using CT imaging for bone mineral assessment, e.g. supported by enhanced image manipulation, were analyzed in several studies like the following:
Quantitative bone mineral analysis using dual energy computed tomography. Genant H K, Boyd D. Invest Radiol. 1977 November-December; 12(6):545-51. PMID: 591258
Precise measurement of vertebral mineral content using computed tomography. Cann C E, Genant H K. J Comput Assist Tomogr. 1980 August; 4(4):493-500. PMID:
Quantitative computed tomography for spinal mineral assessment: current status. Genant H K, Cann C E, Ettinger B, Gordan G S, Kolb F O, Reiser U, Arnaud C D. J Comput Assist Tomogr. 1985 May-June; 9(3):602-4. PMID: 11536558

However, with the benefits of Dual Energy Computed Tomography (DECT), CT imaging also became even more interesting as an additional aid in such traditional MRI diagnosis. In particular, the use of DECT allows for the segmentation and visualization (color-coding) of the bone marrow based on a material decomposition into bone marrow, calcium, water, fatty tissue, calcium, hydroxyapatite and collagen matrix. Thus, the assessment of bone mineral densities based on DECT approaches has been investigated in several studies previously:
Bone mineral assessment: new dual-energy CT approach. Nickoloff E L, Feldman F, Atherton J V. Radiology. 1988 July; 168(1):223-8. PMID: 3380964
Dual-energy CT-based assessment of the trabecular bone in vertebrae. Wesarg S, Kirschner M, Becker M, Erdt M, Kafchitsas K, Khan M F. Methods Inf Med. 2012; 51(5):398-405. doi: 10.3414/ME11-02-0034. Epub 2012 Sep. 28. PMID: 23038636
Dual-energy CT-based phantomless in vivo three-dimensional bone mineral density assessment of the lumbar spine. Wichmann J L, Booz C, Wesarg S, Kafchitsas K, Bauer R W, Kerl J M, Lehnert T, Vogl T J, Khan M F. Radiology. 2014 June; 271(3):778-84. doi: 10.1148/radiol. 13131952. Epub 2014 Jan. 16. PMID: 24475863

In a further step, such use of DECT for bone mineral assessment was further studied with respect to a phantomless approach:
Evaluation of bone mineral density of the lumbar spine using a novel phantomless dual-energy CT post-processing algorithm in comparison with dual-energy X-ray absorptiometry. Booz C, Hofmann P C, Sedlmair M, Flohr T G, Schmidt B, D'Angelo T, Martin S S, Lenga L, Leithner D, Vogl T J, Wichmann J L. Eur Radiol Exp. 2017; 1(1):11. doi: 10.1186/s41747-017-0017-2. Epub 2017 Sep. 20. PMID: 29708178
Eur Radiol. 2015 June; 25(6):1714-20. doi: 10.1007/s00330-014-3529-7. Epub 2014 Dec. 7. Quantitative dual-energy CT for phantomless evaluation of cancellous bone mineral density of the vertebral pedicle: correlation with pedicle screw pull-out strength. Wichmann JL1, Booz C, Wesarg S, Bauer R W, Kerl J M, Fischer S, Lehnert T, Vogl T J, Khan M F, Kafchitsas K.
American College of Radiology (2013) ACR-SPR-SSR Practice Guideline for the Performance of Quantitative Computed Tomography (QCT) Bone Densitometry (Resolution 32). http://www.acr.org/~/media/ACR/Documents/PGTS/guidelines/QCT.pdf. Accessed July 2017

Moreover, during the past decades also the use of MRI to support e.g. radiation therapy (RT) treatment planning, PET attenuation correction and bone quality assessment has increased significantly. This growing trend can be attributed in part to the superior soft-tissue contrast of MRI compared to CT imaging.

However, in consideration of the respective benefits and the combination of CT and MRI technology in order to achieve better results in medical imaging, the use of two separate technologies in parallel causes an increased workload and additional costs for providing and operating the respective systems.

In this context, the technique of synthetic CT, enabling e.g. MR-only radiotherapy workflows, has been developed in recent years.

Synthetic CT provides images generated from MR scans that emulate CT images regarding X-ray attenuation and electron density information. The images provide different Hounsfield units (HU) for different materials and these HU can be converted to electron density in the treatment planning system (TPS) using a calibration curve. A purpose of synthetic CT images is to provide information about X-ray attenuation and electron density to obtain dose calculations with the same accuracy as that of a CT image, enabling e.g. MR-only radiotherapy planning without needing additional CT images.

However, to date, synthetic CT is not capable of providing the same information about the examined tissue than DECT. Hence, DECT analysis of tissue is superior to traditional synthetic CT analysis, in particular with respect to tissue composition like the composition of bone structures.

### SUMMARY

It is an object of the invention to provide a system that is capable of providing a bone volume assessment for individual patients on the basis of respective MRI data and/or synthetic CT data in order to provide an improved and more efficient process with respect to costs and workload by determining additional information from the MRI data and/or synthetic CT data due to specific transformation and processing of data, in order to allow for respective evaluation of the individual patient by utilization of only a single medical imaging process for such individual patient. Moreover, it is an object of the present invention to provide a corresponding method as well as a computer-readable medium.

According to the present invention a system for bone volume assessment based on MRI patient scan data and/or at least one set of synthetic CT data is provided, comprising
at least one processor module for handling and processing of MRI patient scan data,
at least one storage module for storing patient data, in particular MRI patient scan data and/or synthetic CT data and/or data associated therewith, of at least one first patient,
   wherein at least one data connection is provided between the processor module and the at least one storage module, in particular a bidirectional data connection, such that data are transferrable for processing and/or for storing,
   wherein the processor module is further configured:
to receive at least one set of synthetic CT data of the first patient and/or
to receive and/or request MRI patient scan data of a first patient from the storage module or from a MRI scanning device, and to apply a first transfer element on the MRI patient scan data of the first patient such that at least one set of synthetic CT data of the first patient is provided,
   to apply a second transfer element on the at least one set of synthetic CT data and/or MRI patient scan data of the first patient such that reduced patient data of the first patient are generated which provide tissue volume information, in particular water and/or fat volume related information and/or the like, of the first patient, and/or
receiving tissue volume information, in particular water and/or fat volume related information or the like, from the MRI scanning device,
to apply a third transfer element on the reduced patient data and/or the MRI patient scan data of the first patient such that total bone volume information are achieved,
   wherein the processor module is configured to process and/or analyze/evaluate the MRI patient scan data, the at least one set of synthetic CT data and/or the reduced patient data, preferably in combination with each other, such that at least one bone volume parameter, in particular bone mineral density, fat percentage, calcium concentration, total density trabecular space (also referred to herein as total trabecular density) and/or the like, of the first patient is determined.

In examples, the invention is based on the idea that by transformation and further evaluation of MRI patient scan data additional information can be gathered from the respective data set in order to allow for a detailed analysis of the bone composition, in particular of bone volume parameters like bone mineral density, calcium concentration or further parameters concerning the bone composition.

Moreover, as bone mineral density correlates with bone strength, and thus e.g. with pull-out strength of pedicle screws, the further idea underlying the present invention is to optimize healthcare treatment, namely e.g. for optimized placement of screws in the context of unstable spinal fractures, existing spinal instability, degenerative scoliosis, spinal fusion in anterior strut grafting or the like (see Eur Radiol. 2015 June; 25(6):1714-20. doi: 10.1007/s00330-014-3529-7. Epub 2014 Dec. 7. Quantitative dual-energy CT for phantomless evaluation of cancellous bone mineral density of the vertebral pedicle: correlation with pedicle screw pull-out strength. Wichmann J L1, Booz C, Wesarg S, Bauer R W, Kerl J M, Fischer S, Lehnert T, Vogl T J, Khan M F, Kafchitsas K.).

However, as original MRI imaging data do not provide such information in an obvious and immediate manner, the data, as gathered during MRI imaging or by generating synthetic CT data, have to be further processed and/or analyzed in order to emphasize various aspects being specific for corresponding bone compositions such that, in particular by combination of such further processed data, additional information about the bone structure of the first patient and its composition can be gained.

In particular, multiple transfer elements can be provided according to the present invention in order to achieve appropriate data processing starting from MRI patient scan data and/or synthetic CT data for gathering sufficient information for assessment of bone structures, namely to assess bone volume parameters like mineral density as well as further associated parameters of the bone structures of the first patient.

MRI patient scan data particularly refer to the data of the first patient as acquired during a particular MRI scan. Hence, the MRI patient scan data can refer to specific parts of the first patient's body being focused on during MRI scanning process.

Alternatively, it is also possible that synthetic CT data for specific parts of the first patient's body are already provided.

In the context of the present invention, the processor module can be considered as e.g. a single processor unit, a computer or the like, which is suitable for (appropriate) data processing and/or handling.

Moreover, the storage module can be any kind of storage device like e.g. a solid state disc, a hard drive or a database capable of storing and reading/forwarding data, thus for reading and writing of data.

Further, the processor module is configured to apply multiple, in particular three, different transfer elements for the purpose of appropriate data processing, in particular for appropriate processing of MRI patient scan data, in order to provide information about bone volume parameters, like e.g. bone mineral density.

In particular, the different transfer elements can be provided as data processing elements and/or algorithms in order to suitably handle, analyse and/or evaluate the individual first patient's data, starting from a MRI patient scan data set of such individual first patient. Thereby, synthetic CT data can be generated, reduced patient data providing specific information about tissue volume, like e.g. water and/or fat volume related information, of the first patient as well as total bone volume information, preferably separated (or separatable) from the fat volume information of the reduced patient data.

For example, in the context of the present invention it is possible that one MRI patient data set forms the basis of the overall process. These MRI patient data set can preferably be acquired by a single MRI sequence. From such MRI sequence(s), at least one 3D image data sets can be acquired which can subsequently be utilized for generation of at least one synthetic CT data set. Moreover, it is also possible that multiple different synthetic CT data sets are generated on basis of the MRI imaging sequence of the individual patient.

In particular, the application of the multiple transfer elements can be considered as a step-by-step data processing for which the processor module of the system is suitably/appropriately configured.

In case of MRI patient scan data, in particular three transfer elements are applied in order to generate suitable information according to the present invention.

In case synthetic CT data of the first patient are provided, in particular two transfer elements, namely the second and third transfer element(s), can be applicable in order to generate suitable information about bone volume parameter of the first patient.

In particular, by such stepwise data handling/processing the bone volume information can be extracted from the originally provided MRI patient scan data.

In consequence, the present invention provides a reliable and more efficient process for determination of bone volume information, i.e. a bone volume assessment, on the sole basis of MRI patient scan data.

According to a preferred embodiment the first transfer element is trained on basis of the CT patient scan data and MRI patient scan data of a plurality of patients to generate synthetic CT data. Moreover, in another embodiment training data, in particular CT patient scan data and/or MRI patient scan data of a plurality of patients, for training and/or adaption of the first transfer element are stored in the storage module of the system and/or received by the system from a remote data storage.

In particular, the first transfer element is capable of generating synthetic CT patient data on basis of MRI patient scan data. The first transfer element can be trained and optimized on basis of data sets of a plurality of patients in order to improve results provided by the first transfer element.

Thus, MRI patient scans and corresponding CT patient scans can be used in order provide a configuration and/or adaption of the first transfer element such that the first transfer element is enabled to generate synthetic CT patient data on the sole basis of MRI patient scan data of the first patient.

CT and/or MRI patient scan data of such plurality of patients can be stored in the storage module such that the processor module can request such training information for the purpose of configuring and/or adapting the first transfer element.

Alternatively, such data information of the plurality of patients, i.e. MRI patient scan data and corresponding CT patient scan data as training data, can also be stored on and requested from a remote data storage, like a central server or the like.

According to another preferred embodiment the first transfer element is provided in form of a machine learning element/model, in particular in form of a deep learning element/model, a neural net element/model, preferably a neural net of the type of Transformer, Encoder-decoder, diffusion, U-net, V-net, recurrent neural net, recurrent interface network (RIN) or Perceiver IO, or any other kind of a machine learning element/model

Hence, the first transfer element can be trained on basis of given data sets, in particular on basis of MRI and CT patient scan data, in order to be enabled and configured on basis of such given data sets to provide synthetic CT data of the first patient, starting from corresponding MRI patient scan data of the first patient.

Moreover, the first transfer element can also be provided in any other form of a machine learning element as well.

In particular, the quality and effectiveness can be improved from time to time by the quality of learning data as provided and an increasing amount of such learning data.

Thus, the first transfer element can be further improved and configured in order to become more effective and provide results of increasing quality over time.

In one further embodiment of the present invention the CT patient scan data of a plurality of patients is provided in form of respectively two or more sets of CT patient scan data referring to different energy levels, in particular dual energy CT patient scan data, or to unenhanced multi-energy scan data.

In particular, by providing multiple sets of CT patient scan data, i.e. sets being captured of the same patient with different energies, the amount and quality of information as provided by such CT patient scan data can be improved. This information may also be used to generate at least on synthetic CT scan data referring to a specific tube voltage energy level. Moreover, such reference to a specific tube voltage energy level may also be accomplished by specific calibration process of a generated synthetic CT scan data set, such that as a result a specific synthetic CT scan data set is obtained that refers to a specific tube voltage energy.

Hence, the basis for configuration of the first transfer element, i.e. the respective training data basis, can be provided with such additional multi-energy information in order to improve the configuration/adaption of the first transfer element.

According to one embodiment the second transfer element is provided in form of an analysis element of the type Dixon, IDEAL, MAGO, MAGORINO, as a machine learning based water-fat decomposition or an in-phase and/or out-of-phase acquisition based water-fat decomposition or the like in order to determine fat and/or water volume related information from the MRI patient scan data and/or the synthetic CT data.

In particular, the second transfer element preferably provides a separation of fat and water fractions, in particular on basis of the MRI patient scan data of the first patient. Thus, the estimation of the total bone volume can be improved by applying the second transfer element for identification of the fat volume (information).

Preferably, a Dixon analysis can be applied as a second transfer element or e.g. an iterative decomposition of water and fat with echo asymmetry and least-squares estimation (IDEAL).

Moreover, the second transfer element can be provided in form of alternative techniques in the context of determination of water and/or fat volume related information from the MRI patient scan data or synthetic CT data of the first patient as well, like in-phase and out-of-phase acquisition, machine learning based water-fat decomposition or the like (see e.g. US 2021/0270919 A1; Triay Bagur et al., Magnitude-intrinsic water-fat ambiguity can be resolved with multipeak fat modeling and a multipoint search method, Magnetic Resonance in Medicine, Volume 82, Issue 1 p. 460-475; Bray et al., MAGORINO: Magnitude-only fat fraction and R*2 estimation with Rician noise modelling, Magnetic Resonance in Medicine, Volume 89, Issue 3 p. 1173-1192; Liu et al. Robust water-fat separation based on deep learning model exploring multi-echo nature of mGRE, Magnetic Resonance in Medicine, Volume 85, Issue 5 p. 2828-2841).

In summary, bone volume assessment can preferably be performed based on at least one set of synthetic CT patient data generated using a transfer element being trained by one type CT scan data of a plurality of patients. Besides, a fat fraction image can be provided, obtained by using a MRI-based water-fat decomposition transfer element/algorithm like DIXON, IDEAL, MAGO, MAGORINO, machine learning based water-fat decomposition or acquisition based water-fat decomposition (in-phase and/or out-of-/opposed-phase echo times based).

In one further embodiment of the present invention the third transfer element is provided in form of a Nickoloff model element for determination of total bone volume, in particular on basis of MRI patient scan data and/or reduced patient data of the first patient.

In particular, the third transfer element can provide additional information about the total bone volume in order to achieve appropriate results concerning bone volume parameters like e.g. bone mineral density, fat percentage, calcium concentration, total density trabecular space or the like.

For this purpose, preferably a Nickoloff model can be applied as third transfer element in the context of the present invention.

Such Nickoloff model, as preferably applied in the context of the present invention, is also known from the publication Bone mineral assessment: new dual-energy CT approach. Nickoloff E L, Feldman F, Atherton J V. Radiology. 1988 July; 168(1):223-8. PMID: 3380964

Alternatively, the third transfer element can be provided in form of other models or algorithms that allow for an appropriate data processing in order to allow for a further determination of bone volume parameters on basis of MRI patient scan data and/or reduced patient data.

Especially, the Nickoloff model takes water fractions as well as red marrow together, i.e. as one fraction. However, by combination with e.g. a Dixon element as second transfer element, the red marrow fractions (among others comprising water) and yellow fractions (among others comprising fat) can be separated from each other, especially in terms of a comparison of data information as provided by the second and third transfer element.

According to one preferred embodiment the MRI patient scan data are provided by application of (dual-echo/multi-echo) gradient-echo sequences (ME-GRE), (turbo-) spin-echo sequences (TSE), dual-echo steady state (DESS), multi-echo steady state (MESS) sequences, balanced sequences (e.g. bSSFP), (Multi-echo) Ultrashort echo time (UTE) sequences, zero TE (zTE) sequences, synthetic MRI sequences, MR-fingerprinting-based sequences, MR-STAT-based sequences or the like, in particular such that enhanced determination of fat and/or bone volume of the first patient by the transfer elements is provided.

Hence, in the context of the present invention it is also possible to create MRI patient scan data comprising sequences/sets with focus on different information, due to the respectively applied sequence.

The resulting MRI patient scan data in total can provide further information due to the application of specific sequence techniques as mentioned before, like multi-echo, e.g. dual-echo GRE and/or the like.

In another embodiment the MRI patient scan data and/or CT patient scan data are provided and/or stored in DICOM format, HDF5 format, NlfTI format or the like.

Hence, the respective data sets are available in a standard format for medical imaging, ensuring maximum quality and availability.

Moreover, pursuant to a further embodiment of the present invention the system comprises at least one MRI scanning device, wherein the data connection is provided between the MRI scanning device and the at least one processor module and/or the at least one storage module, in particular an unidirectional data connection.

Hence, the system according to the present invention can also comprise the MRI scanning device itself, including a direct data connection to the processor module and/or the storage module.

Alternatively, the MRI scanning device for gathering MRI patient scan data can be situated at a remote location such that the system according to the present invention can be provided with corresponding MRI patient scan data, e.g. via a central server, a remote data connection or the like.

In consequence, the system according to the present invention does not necessarily require to have an MRI scanning device to be specifically assigned to it. Rather, the system according to the present invention can be provided in terms of an independent system whereby MRI patient scan data are provided from different MRI scanning devices via remote data connections.

Hence the system according to the present invention can be considered to comprise no (own/separate/individual) MRI scanning device or to be provided with an own MRI scanning device.

In one embodiment the system further comprises at least one calibration phantom element, wherein the calibration phantom element is applied once for determination of a general calibration factor for MRI patient scan data of a plurality of patients or for each MRI patient scan data of a plurality of patients respectively in order to determine individual calibration factors for the plurality of patients. Moreover, according to one preferred embodiment the at least one calibration phantom element is provided in form of a plurality of tubes and/or balls being filled with a homogeneous or varying water-fat-fractions, preferably within water-fat-fractions in a range of 0 to 100 percent, in particular in a range of 20 to 80 percent.

Hence, by providing a standardized reference value in form of a calibration phantom element, in particular a calibration phantom element with multiple tubes/balls having varying/different water-fat-fractions, the accuracy of the resulting at least one bone volume parameter can be improved.

Moreover, in a further aspect the present invention refers to a method for bone volume assessment based on MRI patient scan data and/or at least one set of synthetic CT data by application of a system according to one of the preceding claims, comprising the following steps:
receiving and/or requesting at least one set of synthetic CT data of the first patient
or
receiving and/or requesting MRI patient scan data of a first patient from the storage module or from a MRI scanning device, and applying a first transfer element on the MRI patient scan data of the first patient such that at least one set of synthetic CT data of the first patient is generated,
applying a second transfer element on the at least one set of synthetic CT data and/or MRI patient scan data of the first patient such that reduced patient data of the first patient are generated which provide tissue volume information, in particular water and/or fat volume related information or the like, of the first patient, and/or
receiving tissue volume information, in particular water and/or fat volume related information or the like, from the MRI scanning device (130),
applying a third transfer element on the reduced patient data and/or the MRI patient scan data of the first patient such that total bone volume information are generated,
   wherein the MRI patient scan data, the at least one set of synthetic CT data and/or the reduced patient data are processed and/or analysed and/or evaluated by the processor module, in particular in combination with each other, in order to determine at least one bone volume parameter, in particular bone mineral density, fat percentage, calcium concentration, total density trabecular space and/or the like, of the first patient on basis of MRI patient scan data of the first patient.

In particular, according to a method of the present invention bone volume assessment can be performed based on at least one synthetic CT/at least one set of synthetic CT data generated using a method trained with CT scans of a plurality of patients.

Besides, a fat percentage image has to be present/provided, which can be obtained using a MRI-based water-fat decomposition algorithm element like DIXON or IDEAL or the like.

Bone volume parameter, like mineral density and/or other associated parameters, can then be obtained by using the Nickoloff method or a process being based on the Nickoloff method.

Finally, a minimum of parameters has to be determined, preferably only one equation has to be used/solved, as both CT value and the fat volume (V_{F}) are known, such that total bone volume (V_{TB}) can be calculated directly.

Moreover, the method according to the present invention is provided to be executable by the sufficiently and correspondingly configured system according to the present invention.

According to another embodiment of the invention, the method further comprises the following steps:
receiving MRI patient scan data of a plurality of patients,
receiving CT patient scan data of a plurality of patients,
applying the MRI patient scan data and the CT patient scan data for training of the first transfer element, preferably in form of a machine learning element, a deep learning element, a neural net element or the like, to generate at least one set of synthetic CT data on basis of MRI patient scan data of the first patient.

In particular, the method according to the present invention ensures that the first transfer element, which generates synthetic CT data for the first patient from the MRI patient scan data of the first patient, is capable of providing an appropriate and sufficient quality of the resulting synthetic CT data.

Such quality can be ensured according to the method of the present invention by appropriate training of the first transfer element, preferably provided in form of a machine learning element like a deep learning element or a neural net element, with MRI patient scan data and corresponding CT patient scan data of a plurality of patients. Hence, by providing an increasing amount of such data of a plurality of patients the first transfer element is even capable of improving over time.

According to a further aspect of the present invention, a computer-readable medium is provided comprising instructions which cause at least one computer (processor) or the like to execute the method according to the present invention.

In particular, the computer-readable medium can be a non-transitory computer-readable medium.

Hence, instructions which are readable and executable by a computer can be stored on any kind of storage medium, e.g. on CDs, DVDs, Flash-storage devices, USB sticks, hard drives, Solid State Discs, or the like.

Further details and advantages of the present invention shall now be disclosed.

### BRIEF DESCRIPTION OF THE DRAWINGS

FIG. 1 is a schematic illustration of an embodiment of a system for bone volume assessment;

FIG. 2 is a schematic flow diagram for a method for bone volume assessment; and

FIG. 3 is a schematic illustration of the method in accordance with FIG. 2, including a step of calibration of the system.

### DETAILED DESCRIPTION

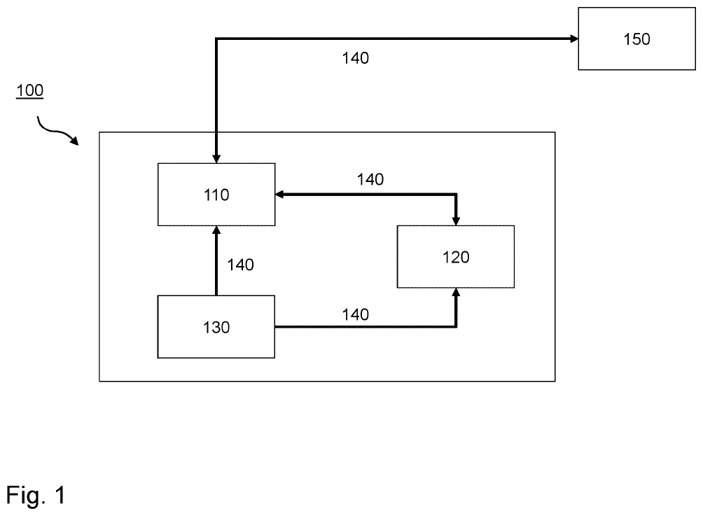

FIG. 1 shows a schematic illustration of an embodiment of a system 100 for bone volume assessment, in particular determination of at least one bone volume parameter such as bone mineral density, fat percentage, calcium concentration, total density trabecular space and/or the like.

According to FIG. 1 the system 100 comprises at least one processor module 110 and at least one storage module 120.

Optionally, the system 100 can further comprise at least one MRI scanning device 130.

The processor module 110 and the storage module 120 can be connected with each other by a bidirectional data connection 140.

Moreover, the optional MRI scanning device 130 can be connected to the processor module 110 and/or the storage module 120.

In particular, the data connection(s) 140 with the MRI scanning device 130 can be provided as unidirectional data connections 140.

Alternatively, the system 100 can be provided without at least one MRI scanning device 130.

In particular, one or multiple MRI scanning devices 130 can for example be situated at remote locations, with the MRI scanning device 130 being in data connection with the system 100, in particular with the at least one processor module 110 and the at least one storage 120 of the system 100.

Moreover, as a further alternative it is also possible that the at least one processor module 110 and the at least one storage module 120 are implemented in the at least one MRI scanning device 130.

With respect to the MRI scanning device 130, the system 100 can be provided as an embedded system, preferably embedded in a corresponding MRI scanning device 130. Furthermore, a remote data storage and/or a server 150 can be connected with the system 100, as shown in FIG. 1.

In particular, the remote data storage 150 can comprise a data connection 140, preferably a bidirectional data connection 140, with the processor module 110 of the system 100.

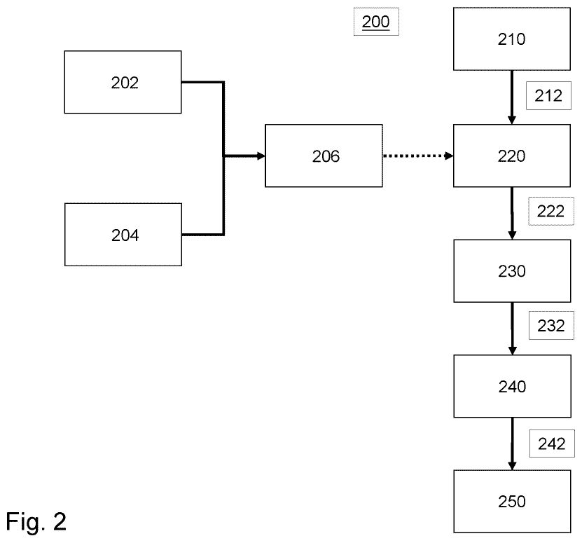

FIG. 2 illustrates a flow diagram according to an embodiment of a corresponding method for bone volume assessment.

In a first step, MRI patient scan data 212 of a first patient can be received and/or requested 210, preferably by the processor module 110, from the storage module 120, a MRI scanning device 130 or a remote data storage 150.

Thus, particularly dependent on whether the corresponding system 100 comprises a MRI scanning device 130, the MRI patient scan data 212 can be directly forwarded to the processor module 110 or can be requested/received from the storage module 120 or a (central) remote data storage 150.

In a next step, a first transfer element 220 is applied/used by the processor module 110 to/on the MRI patient scan data 212 such that synthetic CT data 222 are generated and/or determined and/or elaborated.

In particular, a machine learning element like a neural net can be utilized as first transfer element 220 for transforming/converting MRI patient scan data 212 into synthetic CT data 222.

In another step of the method 200, a second transfer element 230 is applied to the MRI patient scan data 212 of the first patient and/or the synthetic CT data 222 in order to generate and/or determine and/or elaborate reduced patient data 232.

For example, the second transfer element 230 can be provided as a Dixon analysis element, or the like for identification of fat volume information, particularly to optimize the subsequent estimation of total bone volume.

Thus, as an alternative, it may also possible to apply machine learning based water-fat decomposition or other types of (analytical) sequences, like e.g. IDEAL, MAGO, MAGORINO or acquisition based water-fat decomposition (in-phase and/or out-of-/opposed-phase echo times based).

In a further step, a third transfer element 240 can be applied to the MRI patient scan data 212 of the first patient and/or reduced patient data 232 such that at least one total bone volume information 242 is generated and/or determined and/or elaborated.

The third transfer element 240 can preferably be provided in form of a Nickoloff model such that total bone volume information 242 are identifiable.

On this basis, at least one bone volume parameter can be identified/determined 250.

Thus, in summary the method 200 according to FIG. 2 is capable of analyzing and processing MRI patient scan data 210; 212 in a way such that at least one bone volume parameter 250, e.g. bone mineral density, fat percentage, calcium concentration, total density trabecular space and/or the like, of the first patient can be determined.

Moreover, the method 200 according to FIG. 2 also provides a basis for training, i.e. configuration and adaption, of the first transfer element 220.

In particular, MRI patient scan data 202 and CT patient scan data 204 of a plurality of patients can be provided, e.g. on a remote data storage/server 150 or on the storage module 120 of the system 100.

In a next step, the first transfer element 220 is trained 206, based on the MRI and CT patient scan data 202; 204 of the plurality of patients, to generate improved synthetic CT data 222 from a single set of MRI patient scan data 210.

In particular, the first transfer element 220 can be trained 206 once in order to achieve an at least temporarily fixed setting on basis of the currently available set(s) of MRI and CT patient scan data 202; 204.

Alternatively, the first transfer element 220 can be trained 206 on a temporarily basis, e.g. once a month, on demand, e.g. in case a significant amount of additional, new MRI/CT patient scan data 202; 204 is available, or in a (approximately) continuous manner, e.g. each time a new set of MRI/CT patient scan data is available.

Preferably, the first transfer element 220 can be provided in form of a machine learning element.

For example, the machine learning element can be provided as a deep learning element, a neural net element or the like.

Moreover, in the context of the present invention it is also possible that a machine learning element, like e.g. the first transfer element 220, can be trained by/on basis of output results of a Nickoloff model element being applied on CT patient scan data of a plurality of patients.

The quality of synthetic CT data as generated by application of the first transfer element 220 can be improved in an efficient and beneficial manner on basis of MRI and CT patient scan data 202; 204 of the plurality of patients.

In particular, according to an embodiment of the method of the present invention bone volume assessment can be performed based on one synthetic CT/one set of synthetic CT data 222 of the first patient generated using a method trained 206 with one type CT scans as received from of a plurality of patients 202; 204.

Besides, a fat percentage image has to be present/provided, which can be obtained using a MRI-based water-fat decomposition algorithm element like DIXON, IDEAL, machine learning elements or the like, e.g. in form of applying the second transfer element 230.

Bone mineral density and other associated parameters being associated with bone volume information can then be obtained by using the Nickoloff method, e.g. in form of applying the third transfer element 240.

Finally, only one equation has to be used/solved, as both CT value and the fat volume (V_{F}) are known, such that total bone volume (V_{TB}) can be calculated directly 250.

In more detail, such method according to the present invention can make use of the Nickoloff method 240 being based on the following equations, provided with exemplary parameter values according to Koch et al., Accuracy and precision of volumetric bone mineral density assessment using dualsource dual-energy versus quantitative CT: a phantom study, European Radiology Experimental (2021) 5:43 (https://doi.org/10.1186/s41747-021-00241-1):

$${X}^{90} HU = ( {μ}^{90} - {γ}^{90} g ) \cdot {V}_{TB} + ( {β}^{90} t - {γ}^{90} g ) \cdot {V}_{F} + {γ}^{90} g + δ \qquad ( 1 )$$

$${X}^{150} HU = ( {μ}^{150} - {γ}^{150} g ) \cdot {V}_{TB} + ( {β}^{150} t - {γ}^{150} g ) \cdot {V}_{F} + {γ}^{150} g + δ \qquad ( 2 )$$

These exemplary equations (1) and (2) link the exemplary intensities X⁹⁰ and X¹⁵⁰ (given in HU) in the at least one (synthetic) CT series obtained at tube energies of 90 and/or 150 kV to the fraction of the volume occupied by the matrix material (bone mineral+collagen) V_{TB} and the volume of adipose tissue V_{F}. Thereby, the synthetic CT series/set is not obtained with a certain tube energy, but is reconstructed to represent a CT obtained with a certain tube energy.

However, with respect to the present invention parameter V_{F} is already available from the MRI patient scan (data) sequence concerning the first patient. Thus, according to the present invention only one synthetic CT data set is necessary to solve the above equation accordingly.

Moreover, according to the present invention it is particularly possible to use tube energies for the at least one, preferably two, (synthetic) CT series of 20 to 150 kV, preferably of 90 to 150 kV.

The values for t and g may be 0.92 g/cm3 and 1.02 g/cm3, respectively, whereas the other variables (μ⁹⁰, γ⁹⁰, β⁹⁰, μ¹⁵⁰, γ¹⁵⁰, β¹⁵⁰, δ) are energy related constants with e.g. parameter o comprising a constant value of −1000 HU and as can also be gathered for further variable from Table 1 illustrated below, comprising parameter values for different energy level/photon energies:

TABLE 1
Value of Coefficients Used in CT Number Calculations

| Photon | α | | β | θ |
|---|---|---|---|---|
| Energy | (calcium | η | (adipose | (red |
| (keV) | hydroxyapatite) | (collagen) | tissue) | marrow) |
| 40 | 3,628 | 902 | 894 | 938 |
| 50 | 2,543 | 933 | 940 | 955 |
| 60 | 1,951 | 950 | 966 | 971 |
| 80 | 1,396 | 960 | 981 | 979 |
| 100 | 1,176 | 963 | 990 | 983 |
| 150 | 993 | 968 | 999 | 988 |

By calculating the mean intensity for the trabecular bone in both CT data sets, values for V_{TB} and V_{F} can be attained. Finally, the bone mineral density (BMD) value ρBM (given in g/cm3) can be calculated from V_{TB} by application of the material constants I=3.06 g/cm3 and λ=2.11 according to equation (3):

$$ρ BM = \frac{l \cdot {V}_{TB}}{1 + λ} \qquad ( 3 )$$

Further parameters can be identified by equations (4) to (6):

$$μ = \frac{α l + η C λ .}{1 + λ} . \qquad ( 4 )$$

$$ω {ρ}_{W} + θ {ρ}_{M} = γ ( {ρ}_{W} + {ρ}_{M} ) ≡ γ {ρ}_{T} . \qquad ( 5 )$$

$${ρ}_{TB} = \frac{{IV}_{BM} + C {V}_{c}}{{V}_{BM} + {V}_{c}} , \qquad ( 6 )$$

Hence, bone volume assessment, in particular of bone mineral density and/or other associated bone volume parameters, can be determined and evaluated by the method according to the present invention in an efficient manner with particular respect to costs, time and resources.

In particular, results of such bone mineral density assessment can be considered as absolute values. However, when not calibrated perfectly, these values may be considered as relative values, which may still be very useful within an individual person. Such relative values may preferably correlate with bone mineral density maps but may not be exactly similar to such reference values.

Further, according the another exemplary approach in accordance with the present invention, it is also possible to create/receive (one set/series of) synthetic CT data with a specific tube voltage. Water and/or fat fraction can be derived from (corresponding) MRI data.

Calculation of bone mineral density in the case where Fat fraction and a single CT number are known can be executed as follows.

In detail, CT number (CTₙ) can generally be determined by the following formula, on basis of a specific voltage, whereby parameter δ comprises a value of −1000 (i.e. a negative value) and parameter E referring to the water offset number:

$${CT}_{n} = ( μ - γ g ) {V}_{TB} + ( β t - γ g ) {V}_{F} + γ g + δ + ϵ \qquad ( 7 )$$

Parameters V_{F} and V_{TB} are generally unknown, whereby V_{F} can be gathered from results of e.g. Dixon analysis, IDEAL analysis or the like.

Moreover, Ct number parameter CTₙ can be gathered from synthetic CT or from a regular CT.

Hence, on basis of formula (7), the total bone volume V_{TB} can be calculated as follows:

$${V}_{TB} = \frac{( β t - γ g ) {V}_{F} + γ g + δ + ϵ - {CT}_{n}}{- 1 + ( μ - γ g )} \qquad ( 8 )$$

Subsequently, bone mineral density ρ_{BM} can be calculated, similar to the approach as described by Nickoloff, in respect of formula (9) as follows:

$${ρ}_{BM} = \frac{{lV}_{TB}}{1 + λ} \qquad ( 9 )$$

Hence, the present invention also allows for determination and assessment of bone mineral density on basis of created synthetic CT data in an efficient manner.

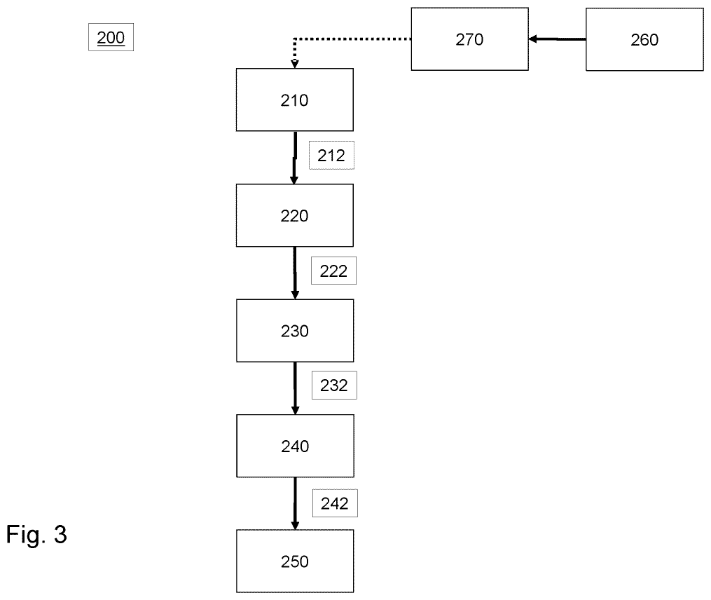

FIG. 3 shows a schematic illustration of the method in accordance with FIG. 2, including a step of calibration of the system 100, in particular of the MRI scanning device 130.

In particular, the process a shown in FIG. 3 deviates from the embodiment according to FIG. 2 by the training 206 of the first transfer element and the calibration 260 of the system 100, preferably of the MRI scanning device 130.

The method according to the present invention can be provided with the step of training 206 of the first transfer element according to FIG. 2, with the calibration step 260 according to FIG. 3 and/or with the training step 206 as well as the calibration step 260.

According to FIG. 3 a calibration phantom element can be provided 260 whereby the calibration phantom element preferably allows for the imaging and post-processing steps to generate images of fat volume to be more precise in order to allow for an improved estimation of fat percentage.

The calibration phantom element can be provided 260 in form of a plurality of tubes and/or balls. The different elements can comprise different water-fat fractions, preferably between/in a range of 0 to 100 percent, in particular in a range of 20 to 80 percent. The calibration phantoms can also comprise a bone mimicking material like hydroxyapatite, calcium, collagen or the like, in concentrations in a range between 0 to 100 percent.

Moreover, resulting T1 and T2 signal weightings can be taken into account for respective optimization of the resulting MRI patient scan data.

On basis of the calibration 270 of the system 100 with the provided calibration phantom element(s) 260, the MRI patient scan data of the first patient can be received/generated 210.

Alternatively, the calibration of the system 100, in particular of the MRI scanning device 130, can also be provided at a later step of the method 200 as shown in FIG. 2 and/or FIG. 3, namely in terms of a calibration of the post-processing of the MRI patient scan data.

In particular, the calibration step 270 can be provided/executed/repeated within (pre-determined) time ranges, e.g. once a day, once a week, once a month, once within six months or the like, or can be provided/executed for each patient respectively.

Further, a single or multiple calibration phantoms may also comprise different substances being of interest, e.g. calcium, collagen or the like.

The system 100, in particular the MRI scanning device 130 and/or the image post-processing, can be calibrated in appropriate manner to allow for an optimized image data quality.

The phrase “patient scan data” may include MRI patient scan data, CT patient scan data, or other scan data.

In summary the present invention particularly discloses a system as well as a method in order to allow for bone volume assessment/evaluation on basis of a single medical imaging technique, namely MRI patient scan data of a first patient.

Moreover, by application of different transfer elements, a.o. a machine learning element as a first transfer element, the MRI patient scan data can be processed for identification of specific information, like fat volume and total bone volume information in order to identify at least one bone volume parameter of the first patient finally, in particular by combination of the processed data.

1. A system for bone volume assessment based on at least one of MRI patient scan data and at least one set of synthetic CT data, comprising:
at least one processor module for handling and processing of MRI patient scan data,
at least one storage module for storing patient data of at least one first patient, the patient data including at least one of patient scan data and synthetic CT data,
wherein at least one data connection is provided between the processor module and the at least one storage module,
wherein the processor module is further configured:
to receive MRI patient scan data of a first patient from at least one of the storage module and an MRI scanning device, and to apply a first transfer element on the MRI patient scan data of the first patient such that at least one set of synthetic CT data of the first patient is generated,
to apply a second transfer element on at least one of the at least one set of synthetic CT data and the MRI patient scan data of the first patient such that reduced patient data of the first patient are generated which provide tissue volume information, including at least one of water-volume-related information and fat-volume-related information of the first patient, and
to apply a third transfer element on at least one of the reduced patient data and the MRI patient scan data of the first patient such that total bone volume information is generated,
wherein the processor module is configured to process the MRI patient scan data, the at least one set of synthetic CT data, and the reduced patient data, to determine at least one bone volume parameter of the first patient,
wherein the bone volume parameter includes at least one of bone mineral density, fat percentage, calcium concentration, and total trabecular density.

2. The system according to claim 1, wherein
the first transfer element is trained on basis of the CT patient scan data and MRI patient scan data of a plurality of patients to generate synthetic CT data.

3. The system according to claim 2, wherein
CT patient scan data and MRI patient scan data of a plurality of patients, for training and/or adaption of the first transfer element are
stored in the storage module of the system.

4. The system according to claim 1,
wherein the first transfer element is provided in form of a machine learning element.

5. The system according to claim 2,
wherein the CT patient scan data of a plurality of patients is provided in form of respectively two sets of CT patient scan data referring to different energy levels.

6. The system according to claim 1,
wherein
the second transfer element is provided in form of an analysis element of the type Dixon, IDEAL, MAGO, MAGORINO, as a machine-learning-based water-fat decomposition element configured to determine fat-volume-related information and water-volume-related information.

7. The system according to claim 1, wherein
the third transfer element is provided in form of a Nickoloff model element for determination of total bone volume information of the first patient.

8. The system according to claim 1, wherein
the MRI patient scan data are provided by application of (multi-echo) gradient-echo sequences, (turbo-)spin-echo sequences, dual-echo steady state (DESS) multi-echo steady state (MESS) sequences, balanced sequences (e.g. bSSFP), (Multi-echo) Ultrashort echo time (UTE) sequences, zero TE (ZTE) sequences, and synthetic MRI (MR-fingerprinting-based, MR-STAT-based), such that enhanced determination of fat volume information of the first patient by the transfer elements is provided.

9. The system according to claim 1, wherein
the MRI patient scan data and CT patient scan data are stored in one of DICOM format, HDF5 format, and NlfTI format.

10. The system according to claim 1,
wherein the system comprises at least one MRI scanning device,
wherein a unidirectional data connection is provided between the MRI scanning device and the at least one processor module.

11. The system according to claim 1:
the system further comprises a calibration phantom element,
wherein the calibration phantom element is applied once for determination of a general calibration factor for MRI patient scan data of a plurality of patients or for each MRI patient scan data of a plurality of patients respectively in order to determine individual calibration factors for the plurality of patients.

12. The system according to claim 11, wherein
the calibration phantom element is provided in form of a plurality of tubes being filled with water-fat fractions in a range of 20 to 80 percent.

13. A method for bone volume assessment based on at least one of MRI patient scan data and at least one set of synthetic CT data, comprising the following steps:
receiving MRI patient scan data of a first patient, and applying a first transfer element on the MRI patient scan data of the first patient such that at least one set of synthetic CT data of the first patient is generated,
applying a second transfer element on at least one of the at least one set of synthetic CT data and MRI patient scan data of the first patient such that reduced patient data of the first patient are generated which provide water-volume information and fat-volume information,
applying a third transfer element on the reduced patient data of the first patient such that total bone volume information is generated,
determining at least one of bone mineral density, fat percentage, calcium concentration, and total trabecular density of the first patient on basis of MRI patient scan data of the first patient.

14. The method according to claim 13, wherein
the method further comprises the following steps:
receiving MRI patient scan data of a plurality of patients,
receiving CT patient scan data of a plurality of patients,
applying the MRI patient scan data and the CT patient scan data for training of the first transfer element to generate at least one set of synthetic CT data on basis of MRI patient scan data of the first patient.

15. (canceled)
